(19) United States
(12) Patent Application Publication
(10) Pub. No.: US 2006/0154592 A1
(43) Pub. Date: Jul. 13, 2006

(54) Air control door with integrated stratification feature

(75) Inventors: Markus Wawzyniak, Rochester Hills, MI (US); William Morgan, South Lyon, MI (US); JongYoun Pak, Rochester Hills, MI (US); Veettil Rajesh, Troy, MI (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Behr GmbH & Co., Stuttgart (DE)

(21) Appl. No.: 11/029,234

(22) Filed: Jan. 4, 2005

(51) Int. Cl. B60S 1/54

(52) U.S. Cl. 454/121

(57) ABSTRACT

An air control door with stratification feature is provided. The door includes a mixing section comprised of air guides that define spaced apart air passages. In a mixed mode application, where mixing of both hot and cold air streams is desired, the air control door directs the two air streams into each other, thereby promoting mixing of such air streams and reducing air stratification. By integrating a mixing section with the air control door, the present invention reduces the size, number and complexity of components required to reduce air stratification to an acceptable level.

### FIELD OF THE INVENTION

The present invention generally relates to a heating and ventilation unit and/or a heating, ventilation and air conditioning unit for a motor vehicle, particularly to a unit comprising a housing with air ducts for supplying, and air doors for controlling, air to the interior of the motor vehicle. An air control door made according to the present invention is particularly advantageous for promoting the mixing of hot and cold air streams and reducing air stratification within a ventilation unit.

### BACKGROUND OF THE INVENTION

Conventional heating and ventilation units and/or heating, ventilation and air conditioning units (collectively “ventilation units”) of the present type are configured to mix cold or temperate air with heated air generated in a heater core. Due to various factors, hot and cold airflows through the air ducts can become stratified: cold air streams remain separate from hot air streams. In some cases, an undesirably large temperature gradient across the outlet openings of the ventilation unit can arise, which gradient can be felt by the occupants of the motor vehicle and cause discomfort. In the case of defrosting or demisting, the temperature gradient across the panel can lead to non-uniform defrosting effects. Vehicle manufacturers generally specify that the air temperature of panel outlets must remain below those of the defrost and floor outlets, and that the defrost and floor outlets remain at similar temperatures. It is, however, not desirable to have too large a temperature gradient between cooler outlets (panel) and warmer outlets (defrost, floor).

Air doors within a ventilation unit are used to control the various airflows. When a “full hot” condition is required, the air doors shut off airflow from non-heated air sources. Conversely, when a “full cold” condition is required, the air doors shut off airflow from the heated air source. In “medium mode” conditions, when temperature other than “full hot” or “full cold” is required, the air doors may be positioned to allow heated and non-heated air streams, in varying degrees, to pass through the ventilation unit. Undesirable air stratification commonly occurs during “medium mode” operation. Although the air doors allow passage of both hot and cold air streams, a conventional air door does not promote the mixing of such air streams.

Prior art approaches to reducing air stratification include stratification baffles that are either integrated into the housings or inserted into the housings as separate parts. These devices, although useful to reducing stratification, increase the tooling complexity and manufacturing costs of the ventilation units. Moreover, these stratification devices are present in the air stream even when not required (full hot and full cold modes), thereby causing undesirable pressure drops, which in turn leads to reduced airflow and increased noise.

Although certain of these approaches and devices have successfully reduced air stratification, there remains a need to promote the mixing of air streams in order to reduce air stratification in a more efficient manner.

### SUMMARY OF THE INVENTION

An air control door with integrated stratification feature is provided. The door includes an integral mixing section comprised of air guides that define spaced apart air passages. The mixing section of the door is operable in a medium mode and is positioned such that hot and cold air streams intersect in a space proximate to the mixing section.

In a preferred embodiment, the air guides of the mixing section are exposed to two air streams only in a medium mode of operation. The air guides are shaped to direct one air stream, and the spaced apart air passages, which are defined by the air guides, direct a second air stream. The mixing section causes the two streams to intersect and mix, thereby reducing air stratification. This arrangement has the particular advantage of promoting the mixing of different air streams while simultaneously controlling the flow rate of air through different ventilation components.

The main body of the air control door is shaped in a manner that accomplishes the desired control of the air streams as is known in the prior art. In a highly preferred embodiment, the main body of the air control door is barrel shaped. In such an embodiment, the mixing section also may be barrel shaped, i.e., the air guides are curved and generally follow the same radius as the remainder of the door. The barrel shape of these highly preferred embodiments of the invention insure that the air streams efficiently pass over and through the main body of the air control door or the mixing section. It is noted, however, that the mixing section may have a different radius than the remainder of the door or an entirely different shape.

The air guides, in a preferred embodiment, include integrated channels through which an airflow, or a portion thereof, may travel. These channels direct a first air stream, and portions thereof, into the region of the ventilation unit in which a second air stream passes, which in turn promotes a more desirable mixing profile. The air guides may be varied in size and/or number. For example, instead of three air guides, which in turn may define, for example, two air passages, an embodiment of the invention may include four air guides, which defines, for example, three air passages.

In yet further embodiments, the size and shapes of the air guides may vary. Embodiments of a door made according to the invention may include, for example, three air guides in which two of the surfaces are identical in shape or size, but a third is different than the other two in shape or size or both. The shape of the air guides determines the mixing characteristics and thus may be tailored to a particular application. For example, in certain embodiments of the invention, the transverse cross-section of a channel is generally u-shaped. In yet another embodiment, semi-circular walls form the transverse cross-section of a channel. Alternatively, or in addition to, the width of the channel within an air guide can remain constant or may narrow as the channel extends from the main body of the door. It should be noted, however, that although the air guides of the described embodiments generally include channels for directing an air stream, including portions thereof, the air paths of the ventilation unit can be designed such that these channels are not needed to promote the mixing of the air streams. In these alternative embodiments, the air guides do not include channels, but instead may be flat or fin-shaped.

Further objects, features and advantages of the invention will become apparent from the detailed description of the preferred embodiments that follows, particularly when considered in conjunction with the attached figures of drawing.

### BRIEF DESCRIPTION OF THE DRAWINGS

Exemplary embodiments of the invention are given below with reference to the drawings, in which:

FIG. 1 is an exterior perspective view of a ventilation unit for a motor vehicle;

FIG. 2 is a simplified interior cross-section of the ventilation unit of FIG. 1 showing hot and cold airflows through the unit when an air control door made according to the present invention is set in a medium mode;

FIG. 3 is a simplified interior cross-section of the ventilation unit of FIG. 1 showing an air control door made according to the present invention as set in full cold mode;

FIG. 4 is a simplified interior cross-section of the ventilation unit of FIG. 1 showing an air control door made according to the present invention as set in full hot mode;

FIG. 5 is a perspective view of an embodiment of an air control door made according to the present invention showing airflows through and around the door when the door is oriented for medium mode operation;

FIGS. 6-8 are perspective views of various embodiments of an air control door made according to the present invention;

FIG. 9 is a side elevation of a door assembly according to the embodiment illustrated in FIG. 6;

FIG. 10 is a perspective view of the door assembly of FIG. 9;

FIG. 11 is a perspective view of an embodiment of an air control door made according to the present invention;

FIG. 12 is a side elevation of the air control door as illustrated in FIG. 1;

FIG. 13 is a side elevation of a door assembly made according to the embodiment of an air control door as illustrated in FIG. 11;

FIG. 14 is a perspective view of the door assembly as illustrated in FIG. 13;

FIGS. 15-16 are perspectives views of an embodiment of an air control door made according to the present invention;

FIG. 17 is a side elevation of the door illustrated in FIGS. 15-16;

FIGS. 18-19 are perspectives views of an embodiment of an air control door made according to the present invention; and

FIG. 20 is a side elevation of the door illustrated in FIGS. 18-19.

### DETAILED DESCRIPTION OF PREFERRED EMBODIMENTS

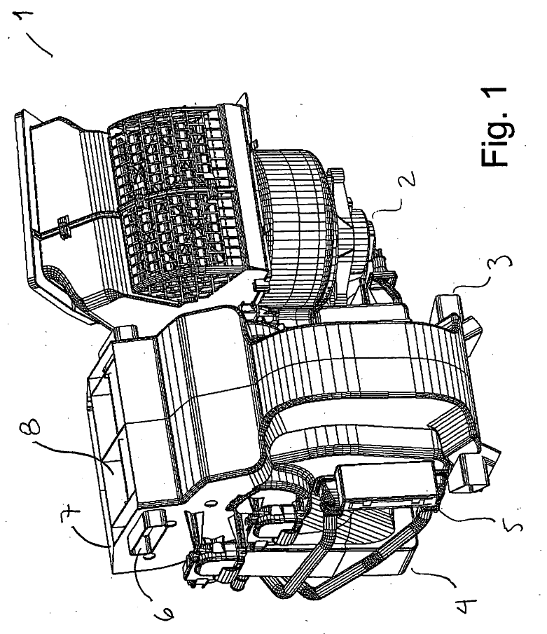

FIG. 1 is an exterior perspective view of a ventilation unit 1 that may be used in a motor vehicle. As is known in the art, the ventilation unit 1 includes a blower 2 that causes air to circulate throughout the unit and into the passenger compartment of a motor vehicle. The ventilation unit typically further includes an evaporator 4, a heater assembly 5, a demist outlet 6, defrost outlet 7, panel outlets 8, and floor outlet 3 (collectively “air outlets”). As air from blower 2 passes over or through the evaporator 4, it is cooled. Likewise, air is warmed as blower 2 forces it over or through the heater assembly 5. Through a selection of appropriate doors and controls, warm and cool air is passed through all or some of the air outlets.

It is desirable from time to time to reduce or completely stop the “cold” air stream, i.e., air that passes through or over the evaporator but not the heater assembly, from exiting through an air outlet. When the ventilation unit is operated in this configuration, it is said to be in a “full hot” mode. Likewise, it is desirable from time to time to reduce or completely stop an air stream that passes through the heater core, i.e., the “hot” air stream, from exiting through an air outlet. When the ventilation unit is operated in this configuration, it is said to be in a “full cold” mode. Between these two extremes, the ventilation unit permits cold and hot air streams to pass to appropriate air outlets. When the ventilation unit is operated in this configuration, it is said to be in a “medium” mode.

As is known in the art, air doors are employed in ventilation units to control the various air streams. These doors block the cold air stream in full hot mode and allow only heated air to pass. They likewise block the hot air stream in full cold mode and allow air that has passed only over or through the evaporator to pass. In medium mode, these doors allow varying proportions of hot and cold air streams to pass depending on the desired temperature in the passenger compartment.

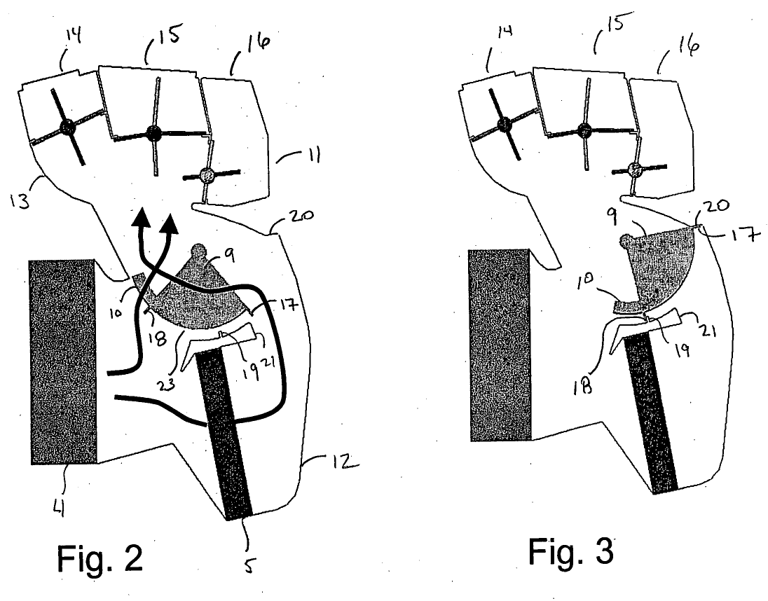

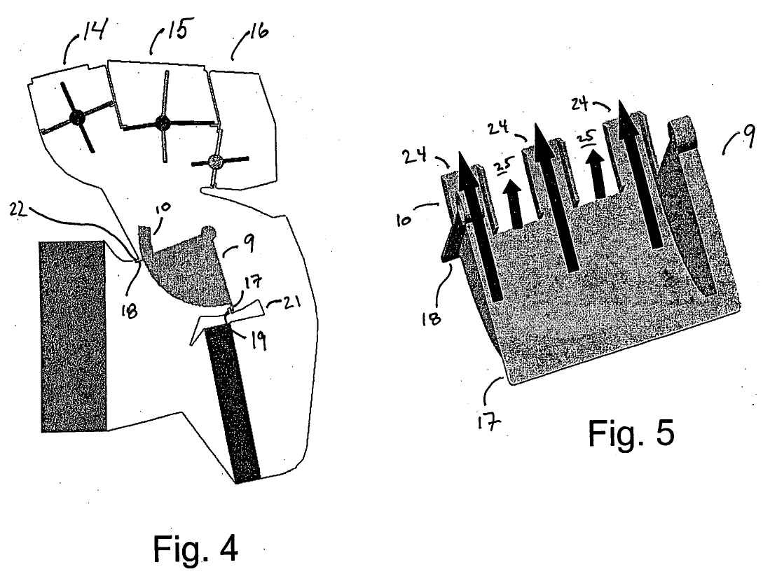

FIGS. 2-4 illustrate an air control door 9 according to the present invention with the position of door 9 determined by its degree of rotation along an axis directed perpendicularly to the illustrated cross sections. FIG. 2 illustrates door 9 set in a medium mode, FIG. 3 illustrates door 9 set in full cold mode, and FIG. 4 illustrates door 9 set in full hot mode. As is evident from the cross-sections illustrated in FIGS. 2-4, door 9 includes a hub at its pivot point. The cross-section of main body 23 of door 9 in the illustrated embodiments is semi-circular in shape, and, for these preferred embodiments, door 9 thus has a cylindrical or “barrel” shape.

In a medium mode, as illustrated by the arrows in FIG. 2, the cold air stream mixes with the hot air stream. The two air streams flow through a housing 11 defined by housing walls 12 and 13 before exiting through air outlets 14-16. In contrast, as illustrated in FIG. 3, the cold air stream, but not the hot air stream, exits through air outlets 14-16. FIG. 4 illustrates the opposite condition in which the hot air stream, but not the cold air stream, is permitted to exit through air outlets 14-16.

Door 9 includes edges 17 and 18, which interface with various portions of the housing in order to block an airflow or airflows. In full cold mode, as illustrated in FIG. 3, door 9 is rotated such that a door edge 17 contacts an end stop portion 20 of housing 11 and door edge 18 contacts an end stop portion 19 of housing component 21. Through the contact of these door edges with the housing, door 9 effectively blocks hot air from exiting through outlets 14-16. In full hot mode, as illustrated in FIG. 4, door 9 is rotated such that door edge 17 contacts an end stop portion 19 of housing component 21, and door edge 18 contacts end stop portion 22 of housing 11. Through the contact of these edges and stops, door 9 effectively blocks the cold air stream from exiting through outlets 14-16.

In certain embodiments of the invention, the mixing section 10 of door 9 does not contact one of a plurality of air streams in either full hot or full cold modes. In highly preferred embodiments of the invention, mixing section 10 extends from between 10 to 90 percent of the prescribed path traveled by the main body 23 of door 9 from end stop to end stop. In such embodiments, the mixing section is in contact with a plurality of air streams through most of the possible rotation of door 9, but it does not interface with the air streams in the remaining rotational travel. This arrangement insures that the mixing section is placed in the path of an airflow only when it is needed, thereby minimizing the pressure drop across the mixing section when it is unneeded. For similar reasons, in certain embodiments of the invention, mixing section 10 extends laterally across only a portion of door 9. In highly preferred embodiments of the invention, mixing section 10 extends from between 10 to 90 percent of the width of door 9.

FIG. 5 is a perspective view of an air control door 9 according to a preferred embodiment. Door 9 includes a mixing section 10 comprised of three air guides 24, which in turn define two spaced apart air passages 25. Air mixing section 10 is integrally formed, attached or molded to door 9. In a preferred embodiment, air guides 24 include at least two air control surfaces, one of which contacts a first air stream and the other contacts a second air stream. Door 9 further includes edges 17 and 18, which mate with the housing as described above. FIG. 5 includes five arrows that illustrate the paths of two airflows at the mixing section 10. A hot airflow, indicated by the three parallel arrows, passes over and through the top of the door 9 whereas a cold airflow passes through the two spaced apart passages 25. The separate airflows, as directed by air guides 24, thus intersect and mix.

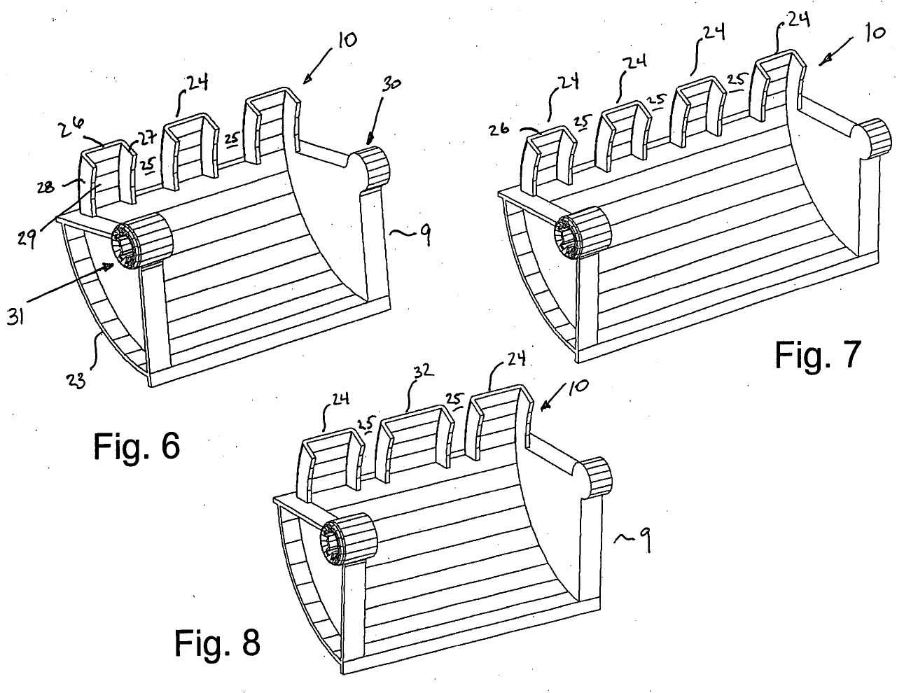

FIG. 6 illustrates an embodiment of an air control door similar to the door illustrated in FIG. 5. Air mixing section 10 includes three air guides 24, which each include a channel 26 defined by channel walls 27-29. Door 9 further includes hubs 30 and 31, which lie along the same axis and permit door 9 to be rotatably mounted to the ventilation unit. In the embodiment of FIG. 6, hub 30 is different than hub 31. In this embodiment, hub 30 is configured to interconnect with a second door whereas hub 31 is configured to interconnect with the housing of the ventilation unit. Persons of skill in the art will readily appreciate that hub 30 could also be identical to hub 31.

Door 9, once mounted to ventilation unit 1, rotates to permit air to flow in varying degrees as is illustrated, for example, in FIGS. 2-4. A distal surface of main body 23 of door 9 is curved and generally follows a constant radius. Unlike the mixing section 10, the distal surface of main body 23 blocks air from passing. In the embodiment of FIG. 6, the distal surface of an air guide channel wall 29 is also curved and, for ease of illustration, is shown as generally following the same constant radius as the distal surface of main body 23. Channel wall 29, however, need not follow the same radius or be curved at all.

Depending on the dimensions of the air guides 24 and the spaced apart air passages 25, a portion of air from the first air stream is directed into channels 26 instead of air passages 25. A second air stream is forced through the spaced apart passages 25 and immediately mixes with the portion of the first air stream that does not flow through channels 26. Subsequently, the partially mixed air streams intersect and mix with the air passing through channels 26. Air guides 24, with or without a channel, thus control a portion of the first air stream as to how and where it mixes with the second air stream.

FIG. 7 is an alternative embodiment of an air control door 9 made according to the present invention. In this embodiment, door 9 is larger than the doors of prior embodiments. Consequently, the mixing section 10 requires four air guides 24, which in turn define three spaced apart air passages 25. As with the embodiment of FIG. 6, air guides 24 include channels 26 defined by channel walls. Although door 9 is larger than the doors of prior embodiments, it is noted that the number of air guides on any size door, such as the door size indicated in FIG. 6, may be decreased or increased depending on the desired mixing characteristics. An increase in the cumulative surface area of the air guides increases the pressure drop of the various air streams in the vicinity of the mixing section 10.

FIG. 8 is yet another embodiment of an air control door 9 made according to the present invention. In contrast with the embodiments of FIGS. 6 and 7, the air guides in the mixing section of the embodiment of FIG. 8 are not identical. A central air guide 32 is larger than two surrounding air guides 24, which collectively define two spaced apart air passages 25. In this embodiment, the mass flow rate and mixing characteristics of the two air streams will be different than in the previously described embodiments. A person of skill in the art will appreciate that air guides 24 alternatively may be larger than the central air guide 32 and/or surrounding air guides 24 need not be identically shaped. Likewise, a person of skill in the art will appreciate that the same mixing section may employ more than three air guides that differ in shape or size. A larger air guide, such as air guide 32, can be substituted for one or more of the air guides 24 in the embodiment of FIG. 7, for example.

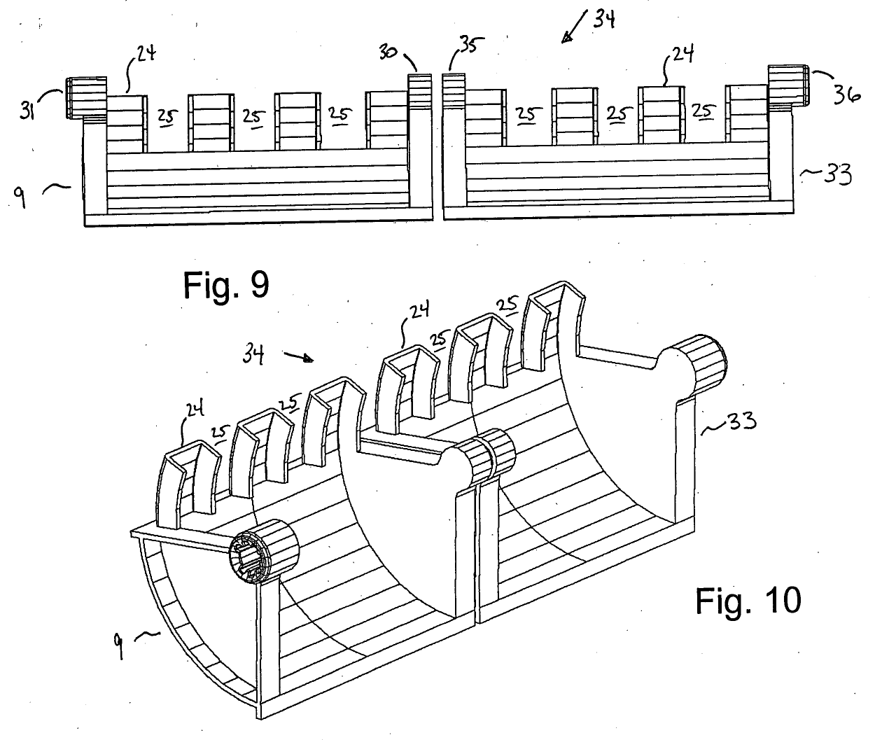

A side elevation of a door assembly 34 is illustrated in FIG. 9 and a perspective view of such assembly is illustrated in FIG. 10. In this ganged relationship, a second air control door 33 is combined with a first air control door 9 to make door assembly 34. As illustrated, hubs 35 and 36 of a second door 33 are reversed when compared with hubs 30 and 31 of a first door 9. The two inner hubs 30 and 35 permit the interconnection of the two doors 9 and 33, and the two outer hubs 31 and 36 permit the connection of the door assembly 34 with the housing of ventilation unit 1. Although the door assembly 34 in FIGS. 9 and 10 generally adheres to the embodiment of a door 9 as illustrated in FIG. 6, it should be understood that different embodiments of the doors, such as the embodiments of FIGS. 7-8 as previously described, may be combined to form an appropriate door assembly. In addition, as will be appreciated by a person of skill in the art, three of more doors may be combined to form an appropriate door assembly depending on the size and requirements of the ventilation unit.

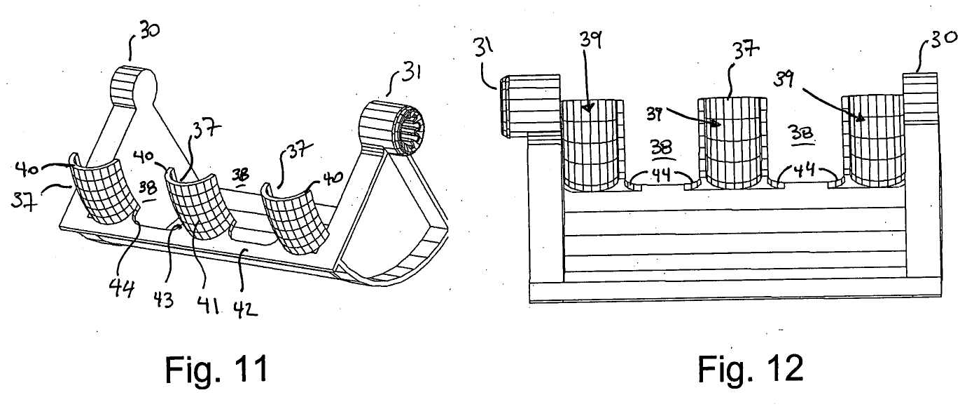

Yet another embodiment of door 9 is illustrated in FIGS. 11 and 12. In this embodiment, mixing section 10 includes air guides 37 having a generally semi-circular transverse cross-section. A person of skill in the art will realize, however, that the curvature need not be exactly circular or semicircular, and may instead, be aerodynamically shaped or curved in such a way as to minimize pressure drop. The transverse cross-section of air guides 37 includes channel walls 40 that define channels 39. Distal surface 41 of air guide 37 may adhere to the shape of the distal surface of main body 23 of door 9, as is illustrated in FIG. 11, or may adhere to a different shape. For example, the radius of curvature of the distal surface 41 of air guide 37 may be larger or smaller than the radius of curvature of the main body 23. Alternatively, distal surface 41 may be straight. The mixing section of this embodiment further includes spaced apart air passages 38 defined by air guides 37. Notches 43 in a guide surface 42 further define the air, passages 38. In the embodiment of FIGS. 11 and 12, notch 43 is generally u-shaped and further includes radial surfaces 44 integrated into guide surface 42. The presence and shaping of notch 43, including radial surfaces 44, promotes desirable mixing of the two air streams.

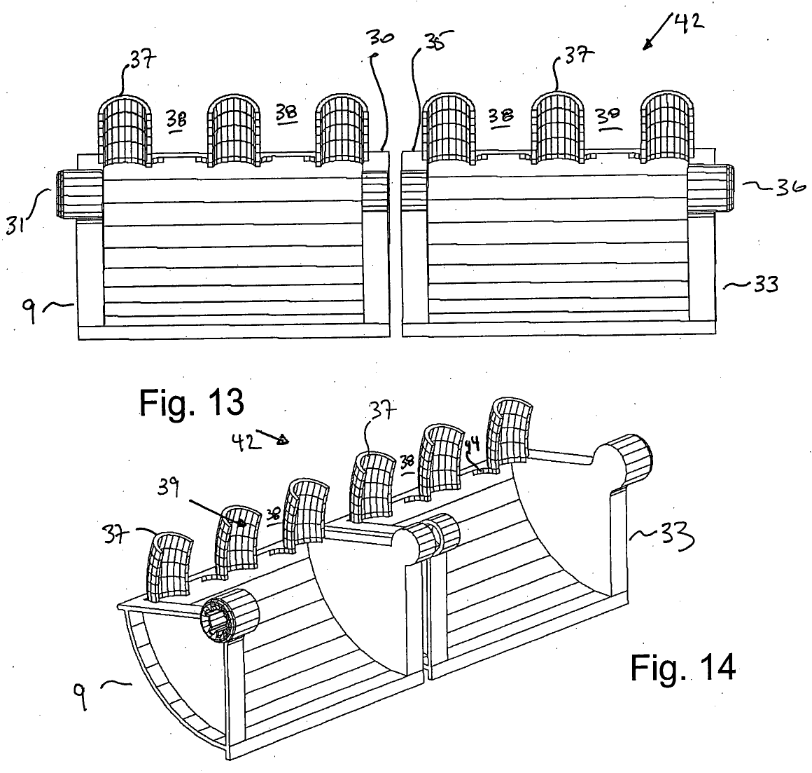

A side elevation of a door assembly 42, which is comprised of two doors made according to the embodiment of FIGS. 11 and 12, is illustrated in FIG. 13. A perspective view of such assembly 42 is illustrated in FIG. 14. In a manner analogous to the embodiments of FIGS. 9 and 10, a second air control door 33 is combined with a first air control door 9 to make door assembly 42. As illustrated, hubs 35 and 36 of a second door 33 are reversed when compared with hubs 30 and 31 of a first door 9. As with the door assembly described in connection with FIG. 9 and 10, it should be understood that different embodiments of the doors may be combined to form an appropriate door assembly depending on the size and airflow needs of a particular ventilation unit.

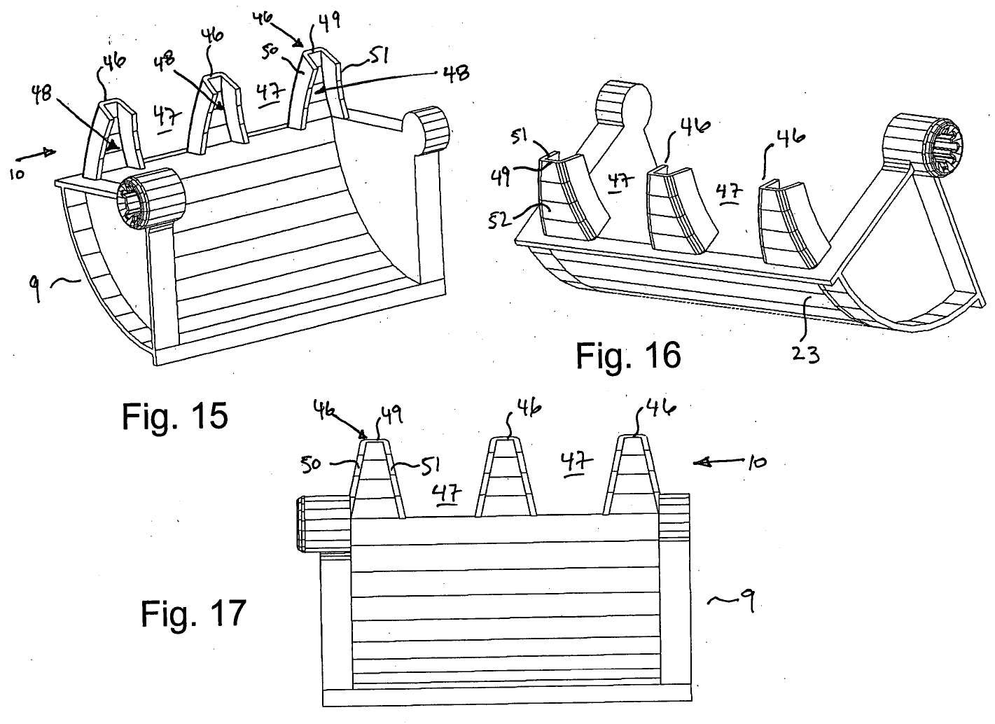

FIGS. 15 through 17 illustrate a embodiment of an air control door in which mixing section 10 includes air guides 46 having a channel 48 defined by channel walls 49-51. The width of channel 48 varies as the channel extends from the main body. Air guides 46, in a longitudinal cross-section, are thus trapezoidal in shape, as illustrated in FIG. 17. In this embodiment, mixing section 10 further includes spaced apart air passages 47 defined by air guides 46. As illustrated in FIG. 16, a distal surface 52 of channel wall 49 is curved and, as illustrated, generally adheres to the shape of main body 23 of door 9. As with the prior embodiments, the shape of distal surface 52 need not be the same as or even similar to the shape of main body 23. For example, the radius of the curvature of the air guide's distal surface may be larger or smaller than the radius of curvature of main body 23.

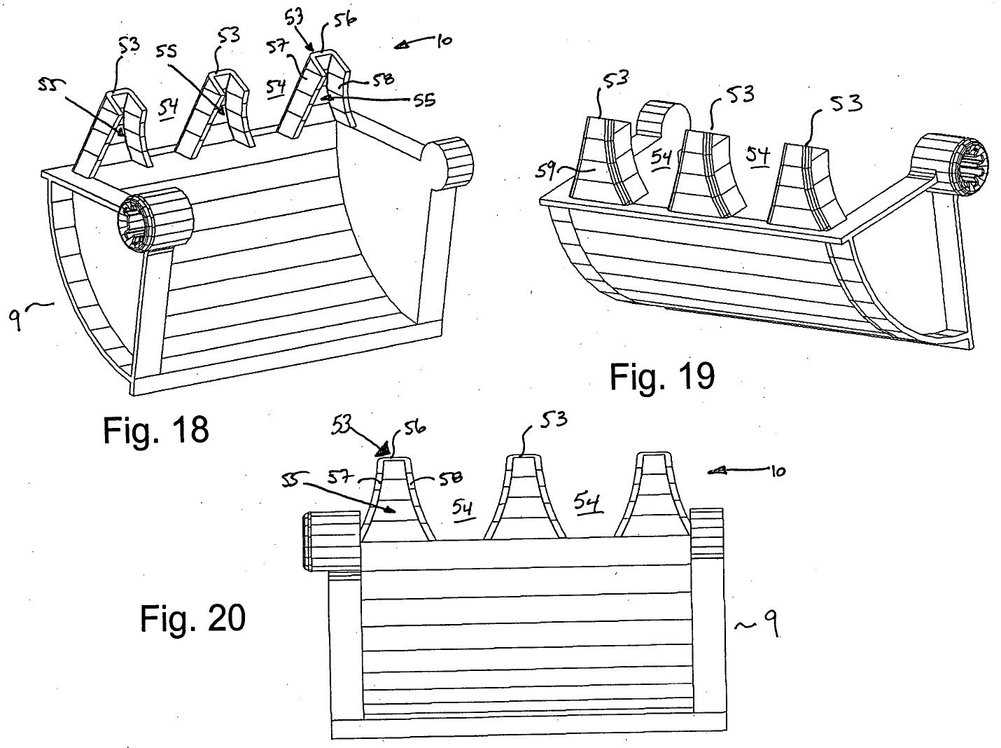

FIGS. 18 through 20 illustrate yet additional embodiments of an air control door made according to the present invention. In these embodiments, air guides 53 include channels 55 (defined by channel walls 56-58) that progressively narrow along u-shaped transverse cross-sections. In comparison to the air guides illustrated in the embodiments of FIGS. 15-17, the width of channels 55 vary at a non-uniform rate as the channel extends from the main body. FIG. 20, which is a side elevation of this embodiment of door 9, illustrates the non-linear rate of change for the width of channels 55. In this embodiment, mixing section 10 also includes spaced apart air passages 54 defined by air guides 53. The distal surface 59 of channel wall 56 is curved and, as illustrated, generally follows the shape of main body 23 of door 9. As with the prior embodiments, however, the shape of distal surface 59 need not be the same as or similar to the shape of distal surface 23. For example, the air guide's distal surface may be straight and not curved.

Each of the different shapes of the channels in the previously described embodiments causes air to flow differently over and through the mixing section 10 of door 9. By using different transverse and longitudinal shapes for the air guides, an HVAC designer has increased control over the mixing characteristics of two or more air streams. By shaping the air guides in an aerodynamically desirable manner, it is also possible to minimize pressure drop and noise generated by the air stream moving over and through the air guides. In the various embodiments, for example, the portion of an air stream that passes through the channels will be directed downstream with a greater velocity than air that does not pass through channels. By varying the shape and/or width of the channels, the mass flow rate through the channel, as well as the velocity of the air, can be controlled. The portion of a first air stream that passes through a channel will thus mix with the second air stream in a location downstream from the location of where the remainders of the air streams mix.

Alternative embodiments of the invention (not illustrated) that are within the scope of the invention include channels that are integrated into the main body 23 of door 9. In these embodiments, the channels direct a different air stream than the channels in the air guides as described above. It is also contemplated that the air guides need not include channels at all. Instead, in such embodiments, the mixing section includes projections that direct an airflow but are not channel shaped, e.g., flat or fin-like projections. Various permutations and combinations of channels, or the absence of channels, in both air guides and door surfaces are possible and made known to persons of skill in the art by reference to the foregoing written description and attached drawings. Finally, although the foregoing included a description of the preferred embodiments with reference to a single mixing section 10 integrated with the main body of door 9, persons of skill in the art will also appreciate that additional mixing sections could be added. For example, door 9 can include a first mixing section at one end of its rotational travel and a second mixing section at the other end of its rotational travel.

It will be apparent that further modifications may be made to the invention, and that some or all of the advantages of the invention may be obtained. Also, the invention is not intended to require each of the above-described features and aspects or combinations thereof. In many instances, certain features and aspects are not essential for practicing other features and aspects. The invention should only be limited by the appended claims and equivalents thereof, since the claims are intended to cover other variations and modifications even though not within their literal scope.

What we claim is:

1. An air control door for use in a ventilation unit comprising:
a main body that rotates on an axis and blocks a predetermined amount of air from flowing through the ventilation unit depending on its angle of rotation; and
a plurality of air guides attached to the main body, wherein the air guides define at least one air passage in which air from a plurality of air streams mixes.

2. The air control door according to claim 1, wherein the main body is substantially barrel shaped.

3. The air control door according to claim 1, wherein the air guides are substantially barrel shaped.

4. The air control door according to claim 1, wherein at least one of the air guides includes a channel.

5. The air control door according to claim 4, wherein the width of the channel is constant.

6. The air control door according to claim 4, wherein the width of the channel varies.

7. The air control door according to claim 6, wherein the width of the channel varies at a constant rate.

8. The air control door according to claim 6, wherein the width of the channel varies at a non-linear rate.

9. The air control door according to claim 1, wherein all of the air guides include a channel.

10. The air control door according to claim 1, wherein all of the air guides are identically shaped.

11. An air control door mounted within a motor vehicle ventilation unit comprising:
a main body that rotates on an axis and blocks a predetermined amount of air from flowing through the ventilation unit depending on its angle of rotation; and
a mixing section defined by a plurality of air guides and at least one air passage, wherein the mixing section permits a predetermined amount of a first air stream to mix with a second air stream depending on the angle of rotation of the main body.

12. The air control door according to claim 1, wherein the mixing section is not exposed to the first air stream when the main body is rotated to a first position.

13. The air control door according to claim 11, wherein the mixing section is not exposed to a second air stream when the main body is rotated to a second position.

14. The air control door according to claim 11, further including a second mixing section defined by a plurality of air guides and at least one air passage, wherein the second mixing section permits a predetermined amount of the first air stream to mix with the second air stream depending on the angle of rotation of the main body.

15. A rotatable air control door for use within the housing of a ventilation unit and located at an intersection between two different temperature air streams, said air control door comprising:
a first surface that, when rotated into a first position, blocks substantially all of the air from a first air stream from traveling through the housing while simultaneously permitting substantially all of the air from a second air stream to travel through the housing; and
a second surface integrally attached to the first surface and located such that, when the first surface is rotated into the first position, the second surface does not contact air from the first air stream, and, when the first surface is rotated to a second position, the second surface is in fluid communication with both air streams and blocks a predetermined amount of the first air stream from traveling through the housing.

16. The air control door according to claim 15, wherein the amount of rotation of the first surface from the first position to the second position determines the amount of air from the first air stream that is blocked from traveling through the housing.

17. The air control door according to claim 15, wherein the second surface includes a plurality of air guides that define at least one air passage through which air from both air streams may travel.

18. The air control door according to claim 17, wherein at least one of the air guides includes a channel.

19. The air control door according to claim 17, wherein a longitudinal section of the air guides is substantially trapezoidal.

20. The air control door according to claim 17, wherein the width of the channel varies.
